(19) United States
(12) Patent Application Publication
(10) Pub. No.: US 2016/0332847 A1
(43) Pub. Date: Nov. 17, 2016

(54) STACKER CRANE WITH AN INTERMEDIATE STORAGE AREA FOR CONTAINERS

(71) Applicant: TEREX MHPS IP MANAGEMENT GMBH, Düsseldorf (DE)

(72) Inventors: Mike Hegewald, Düsseldorf (DE); Armin Wieschemann, Oberhausen (DE)

(21) Appl. No.: 15/112,502

(22) PCT Filed: Jan. 20, 2015
(86) PCT No.: PCT/EP2015/051027

§ 371 Date: Jul. 19, 2016

(30) Foreign Application Priority Data
Jan. 21, 2014 (DE) 10 2014 100 658.5

(51) Int. Cl. B66C 19/00; B65G 63/00

(52) U.S. Cl. CPC B66C 19/007; B65G 63/004

(57) ABSTRACT

A stacker crane for handling containers comprising at least one horizontal cross member which can be moved in a crane travel direction and on which a crane trolley can be moved along and transverse to the crane travel direction. The stacker crane additionally includes a load receiving means for a container suspended on the crane trolley and being liftable and lowerable. At least one intermediate storage area for at least one container is arranged on the stacker crane. The intermediate storage area can be reached by the load receiving means and can be moved together with the stacker crane in the crane travel direction. The intermediate storage area is designed so as to be movable between an active position in which a container can be received and a passive position in which no containers can be received.

### CROSS REFERENCE TO RELATED APPLICATION

The present application claims priority benefits of International Patent Application No. PCT/EP2015/051027, filed on Jan. 20, 2015, and claims benefit of DE 10 2014 100 658.5, which are hereby incorporated herein by reference in their entireties.

### BACKGROUND OF THE INVENTION

The invention relates to a stacking crane for handling containers, in particular ISO containers, having at least one horizontal transverse girder, which can travel in a crane travel direction and along which a crane trolley can travel in and transverse to the crane travel direction, having a load picking-up means for a container, which load picking-up means is suspended on the crane trolley and can be raised and lowered, wherein at least one intermediate storage area for at least one container is disposed on the stacking crane, the intermediate storage area can be reached by the load picking-up means and can travel together with the stacking crane in the crane travel direction. The invention also relates to a container storage system having a stacking crane and a container store.

Stacking cranes are used for handling standardized load carriers, in particular ISO containers, in particular within the management of container stores and the placement of containers into the container store and removal of containers from the container store effected under such management. Therefore, the corresponding stacking cranes differ from container bridges for loading and unloading a ship, which transport the containers between the ship and the quay but without placing the containers into the container store or removing them therefrom. The stacking crane, which is formed as a gantry crane, reaches over its working region in the form of a container store. It can travel in a linear manner via running gear units on two parallel tracks, e.g. rails, on which it is supported with four upright supports. A trolley running gear unit can travel in a linear manner on transverse girders horizontally straddling the containers and connecting the supports. A one-piece rigid mast is suspended on the trolley running gear unit, is able to travel vertically in the raising and lowering direction and has a load picking-up means for containers suspended at the lower end thereof. A stacking crane of this type is described e.g. in the German patent DE 10 2008 061 199 B3.

The stacking crane straddles the container store having a plurality of rows of containers which can be stacked next to and above one another. The straddle width of the gantry of such a stacking crane is determined by the frequency during placement into and out of storage and the dwell time of containers in the store; it can amount to a 1 over 5 solution between 8 and 11 containers and permits economic storage at high density, maximum use of space, with good sorting and short access times.

Such stacking cranes are used for intermodal handling in rail terminals between rail and road, for trimodal handling in freight terminals between ships, goods trains and lorries, and for handling in container stores in manual, semi-automatic or automatic operation. Since generally little surface area is available for the storage of containers, owing to the large spanning width of the gantries they permit management of storage modules with a large storage capacity. Depending on size and area of use, the stacking cranes are designed as a purely box-like construction or a combination of framework and box-like construction. In the case of large construction heights they thus have a high level of bending stiffness and permit safe operation even in strong winds.

In addition to the required maximum use of space, the productivity of the container store operation is of central significance. This is in turn definitively dependent on the times of placement into and out of storage of the containers and the transport times of the containers to and from the target locations. In modern container terminals semi-automated or fully automated stacking cranes, which are operated with optimized sequential controls, are increasingly being used today. Automated stacking cranes which are known by the abbreviation ASC are already largely meeting the requirements for high productivity and, in port handling, form well integrated system solutions incorporating conventional water-borne and land vehicles.

Since global container traffic is constantly increasing and the volume of cargo, the size of ships and handling volumes are constantly growing, the increase in performance of existing and new terminals must also be adapted in order to keep step with growth. There is therefore an increasing need for innovative container handling apparatuses and systems with high levels of handling performance and high working rates.

A stacking crane of gantry construction is known from DD 257 420 A1, having an intermediate storage area for a plurality of containers on each support of the gantry thereof. The intermediate storage areas are disposed in the region of the respective lower end of the support above the running gear units of the stacking crane. The set-down surfaces—for the containers—of the intermediate storage areas extend horizontally. The intermediate storage areas protrude inwards in the direction of the opposite supports and outwards beyond the supports so that the travel lane of the stacking crane corresponds to the width of the intermediate storage areas.

### SUMMARY OF THE INVENTION

The present invention provides an improved stacking crane such that the working region thereof is enlarged and the handling performance is thereby raised and therefore an increase in the productivity of the container storage system is achieved.

In accordance with an embodiment of the invention, in a stacking crane for handling containers, in particular ISO containers, having at least one horizontal transverse girder, which can travel in a crane travel direction and along which a crane trolley can travel in and transverse to the crane travel direction, having a load picking-up means for a container, which load picking-up means is suspended on the crane trolley and can be raised and lowered, wherein at least one intermediate storage area for at least one container is disposed on the stacking crane, the intermediate storage area can be reached by the load picking-up means and can travel together with the stacking crane in the crane travel direction, an increased working region is achieved in that the intermediate storage area is designed in such a way that the intermediate storage area can move between an active position in which a container can be picked up, and a passive position in which no container can be picked up.

Owing to the fact that the intermediate storage area can move between an active position for picking up a container and a passive position in which no container can be picked up and the intermediate storage area cannot be reached by the load picking-up means, the intermediate storage area can be positioned in the passive position such that it or the set-down surface thereof can no longer be approached by the load picking-up means in such a way that a container can be set down on the set-down surface of the intermediate storage area. In this way, the intermediate storage area is removed from the working region of the stacking crane or the load picking-up means, whereby the working region or the accessibility thereof is enlarged. This function is important since a container set down on the intermediate storage area or even an intermediate storage area located in the active position without a container limits the travel path of the crane trolley or of the load picking-up means along the transverse girder, and the row of containers in the container store below the intermediate storage area moved into the active position can no longer be reached by the stacking crane or the load picking-up means thereof since the container and also the intermediate storage area hinders lowering of the load picking-up means. Owing to the fact that the intermediate storage area can move out of the active position into the passive position, the stacking crane can be operated like a conventional stacking crane and reach all containers in the container store. In this way, a particularly short distance between the set-down outer containers of the container store and the supports of the stacking crane is also possible, whereby the working region is advantageously increased. By reason of the intermediate storage area it may be necessary also to perform a relocation step prior to picking up the containers; however, there is a saving in overall travel.

The intermediate storage area is in this embodiment fixedly connected to the stacking crane and is able to travel therewith in the crane travel direction. This constructionally simple solution makes it possible to clearly increase the productivity of the stacking crane or of the container storage system since empty travel of the stacking crane can be reduced and paths can be shortened. Thus, in the intermediate storage area, the stacking crane can pick up containers which are intended for destinations lying in the travelled direction of the crane. Therefore, the container store can at least be reorganized in a manner favorable to handling. The stacking crane does not have to travel back along the path once more in the empty condition for the additionally picked-up container deposited on the intermediate storage area, but removes the container already carried along directly from the intermediate storage area. The environment is also protected by a saving in travel because less energy is consumed. Since such stacking cranes usually operate automatically and together with a store management computer, the containers can therefore be brought through forward-planning and with the aid of the intermediate storage area to logistically favorable locations within the container store.

In conjunction with the present invention, ISO containers are understood to be standardized large-volume or sea-freight containers which are used in the international transportation of goods. The most widely used are ISO containers with a width of 8 feet and a length of 20, 40 or 45 feet.

Provision is advantageously made in constructional terms for the intermediate storage area to be able to pivot about a horizontal axis between the active position and the passive position. In this way the intermediate storage area can be removed in a particularly simple manner from the working region of the stacking crane or of the load picking-up means.

In particular, provision is made for the intermediate storage area to be disposed below and in the proximity of the transverse girder in such a manner that, in relation to the height thereof, the load picking-up means can set down precisely one container on the intermediate storage area. Therefore, in the container store, the containers can be stacked in the provided height and a stacking crane can travel with a picked-up container over the container store.

In an advantageous manner, the intermediate storage area is disposed at the end of the transverse girder and therefore at the edge of the container store. Therefore, the handling of the containers or the working region is limited to the least extent since, in the active position of the intermediate storage area, only one row of containers cannot be reached by the load picking-up means.

In a preferred embodiment, the stacking crane is constructed in the manner of a bridge or gantry.

In an advantageous manner, a plurality of intermediate storage areas are disposed on the stacking crane. For example, two at opposing ends of the transverse girder.

The stacking crane is preferably of a gantry construction, the at least one horizontal transverse girder is supported via a plurality of upright supports and the at least one intermediate storage area is disposed on at least one of the supports.

In an advantageous manner, the load picking-up means can be guided via a rigid, one-piece mast on the crane trolley.

The above-described stacking crane is particularly suitable for a container storage system having a stacking crane in which, in a container store disposed below the stacking crane, containers are stacked in rows next to and above one another and behind one another in the crane travel direction, the transverse girder straddles the container store and the intermediate storage area is disposed on the stacking crane in a region above a maximum provided container stacking height of the container store. In order to hinder the travel of the stacking crane as little as possible, the intermediate storage area is disposed on the stacking crane in a region above the maximum provided container stacking height of the container store. Since the intermediate storage area protrudes inwards, collisions with the container stacks are reliably avoided. This is assured since the intermediate storage area is provided at a height above the uppermost stacked container, or the stacking height of the containers in the travel region of the intermediate storage area which can travel with the stacking crane is reduced.

Incidentally, the intelligent control of the stacking crane, under consideration of the travel profile of the stacking crane, ensures collision-free stacking and loading of containers.

The invention can be implemented in many ways. Thus, with the stacking crane in accordance with the invention, even during placement of a container into the container store or removal of a container from the container store, at least one further container can be held in readiness on the intermediate storage area in accordance with the invention and can be moved with the stacking crane. In this way, the travel path can at least be shortened or there can be a saving in travel of the stacking crane when empty. In order to avoid collisions with occupied stacking areas or apparatuses, the occupation of the intermediate storage area is to be incorporated into the control of the stacking crane.

The seemingly simple solution of the invention increases the productivity of a container storage system by simple means. The shortened transport time increases the through-put and the frequency of placement into and out of storage. The energy saved meets the environmental protection demands of the operators when container terminals are obtaining approval and saves the operator in terms of operating costs. The invention is explained in more detail herein under with the aid of an exemplified embodiment illustrated in the drawings.

### BRIEF DESCRIPTION OF THE DRAWINGS

FIG. 1 is a schematic illustration of a stacking crane of gantry construction in accordance with an aspect of the invention; and

FIG. 2 shows a side view of the stacking crane according to FIG. 1.

### DESCRIPTION OF THE PREFERRED EMBODIMENTS

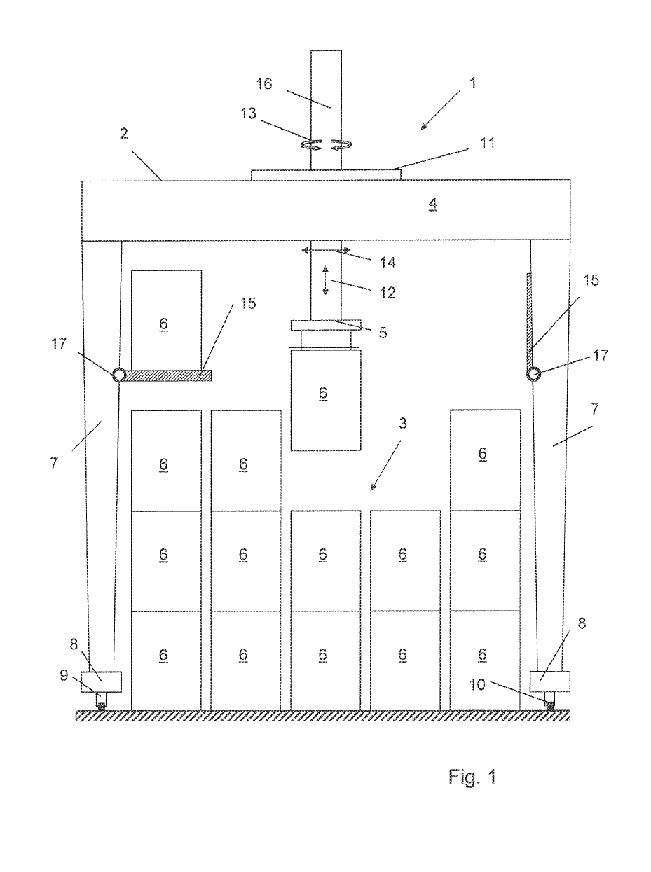

FIG. 1 shows a stacking crane 1 which substantially consists of a gantry-like frame 2, in particular box frame, which straddles a container store 3. The frame 2 is substantially constructed from two mutually spaced and mutually parallel, horizontal bridge-like transverse girders 4 which are supported on vertical supports 7. A load picking-up means 5, preferably a so-called spreader, for containers 6 is suspended on the transverse girders 4 via a vertically extending mast 16 on a crane trolley 11. The two transverse girders 4, of which only the front one can be seen in FIG. 1, are supported to form the frame 2 in gantry form from four upright supports 7, of which once again only the front supports can be seen in FIG. 1. On a respective side of the container store 3, the supports 7 are connected in their lower region by a travel frame 8 which receives running gear units 9 of the stacking crane 1. By means of the running gear units 9, the stacking crane 1 can travel on rails 10 in a crane travel direction F, wherein the rails 10 extend on both sides of the container store 3 in parallel with one another, in the crane travel direction F and therefore perpendicular to the plane of the drawing in FIG. 1. The load picking-up means 5 is suspended on the trolley running gear unit 11; the trolley running gear unit 11 is able to travel on the transverse girders 4 and along the transverse girders 4. By means of the load picking-up means 5, raising and lowering 12 and rotation 13 of the containers 6 attached to the load picking-up means 5 are possible. By means of the crane trolley 11, lateral travel of the containers 6 in a travel direction 14 along the transverse girders 4, and, by means of the running gear units 9, travel in the direction of the rails 10 extending in the crane travel direction F are possible. In this way, each region below the stacking crane 1 can be reached and served by the load picking-up means 5 along its travel path in order to be able to pick up or set down a container 6 in this working region below the transverse girders 4 and between the supports 7.

In FIG. 1, in the left upper corner of the stacking crane 1 and therefore at the left end of the transverse girder 4, a first intermediate storage area 15 for a container 6 is provided which is disposed in a positionally fixed but foldable manner laterally on the two supports 7 disposed one behind the other. The intermediate storage area 15 is able to pivot about a horizontal axis 17 between an active position for picking up a container 6 into a passive position in which no container 6 can be picked up and the intermediate storage area 15 cannot be reached by the load picking-up means 5. The intermediate storage area 15 is suitable for picking up a container 6 and is dimensioned accordingly. In this case, the intermediate storage area 15 extends with its set-down surface for the container 6 to be picked up in the active position substantially horizontally and in parallel with the transverse girder 4 in the direction of the opposing supports 7 so that, as shown in FIG. 1, a container 6 can be set down on the first intermediate storage area 15. In this way, the intermediate storage area 15 protrudes in the active position into the working region of the load picking-up means 5 so that the containers 6 of the outer left container row disposed immediately next to the supports 7 cannot be reached by the load picking-up means 5.

In the same way, in FIG. 1, in the region of the opposite right end of the two transverse girders 4 a second intermediate storage area 15 is provided which is likewise disposed on the associated supports 7. The second intermediate storage area 15 is shown in the passive position in which the set-down surface of the intermediate storage area 15 extends substantially vertically and in parallel with the supports 7 and on the supports 7. In this way, the containers 6 of the container row disposed immediately next to the right supports 7 can be reached by the load picking-up means 5. For this purpose, the second intermediate storage area 15 was pivoted upwards through about 90 degrees about the horizontal axis 17. Owing to the fact that the second intermediate storage area 15 with its set-down surface in the passive position no longer extends horizontally into the working region of the load picking-up means 5, the second intermediate storage area 15 in the passive position can no longer be reached by the load picking-up means 5 such that a container 6 can be set down on the second intermediate storage area 15. In order to be able to pick up a container 6, the intermediate storage area 15 must be moved to the active position.

The arrangement of the two intermediate storage areas 15 on the stacking crane 1 is selected such that the load picking-up means 5 in an upper position can set down the container 6 on an intermediate storage area 15 located in the active position and can pick it up therefrom. At the same time, however, the intermediate storage areas 15 are disposed at such a height that the intermediate storage areas 15 in the active position, during travel of the stacking crane 1 on the rails 10 do not collide with the containers 6 stacked in the container store 3. As illustrated, the containers 6 in the exemplified embodiment are stacked in five rows next to one another and in three rows one above another; in practice, stacking heights of five to six containers in up to 11 rows are not unusual. Each intermediate storage area 15 is therefore disposed in the region above the container store 3 in which the containers 6 are moved by the stacking crane 1.

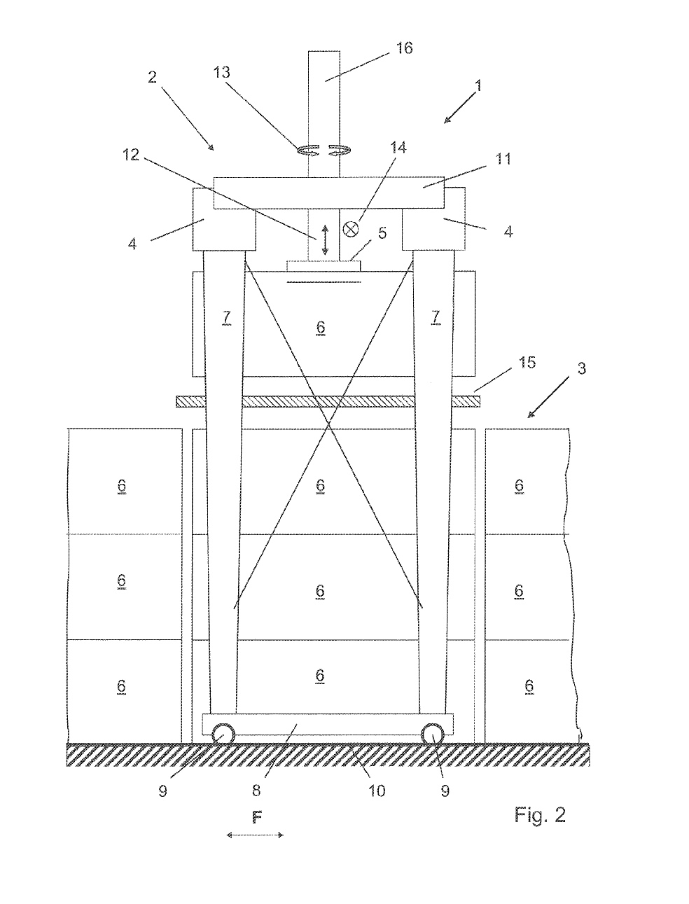

FIG. 2 shows a side view of the stacking crane 1. A schematically illustrated crane trolley 11 is shown, having the rigid, one-piece mast 16 which can be raised and lowered and can rotate about the vertical axis. The mast 16 is moved in the raising and lowering direction 12 via cable winches—not shown—disposed on the crane trolley 11. The crane trolley 11 is able to travel perpendicularly to the plane of the drawing on the two transverse girders 4 of the stacking crane 1. It is also possible to see the front two of the four supports 7 of the stacking crane which face the viewer and which form one side of the gantry-like frame 2 extending over the container store 3. The supports 7 are connected at their lower ends to the travel frame 8, on which, as indicated, the running gear unit 9 is disposed which moves the stacking crane 1 on the rails 10 extending in the travel direction F. In the upper region of the stacking crane 1 one of the intermediate storage areas 15 for a container 6 is shown by cross-hatching. The container 6 to be set down on this intermediate storage area 15 located in the active position has been raised by the load picking-up means 5 into an upper position and is then set down on the intermediate storage area 15 so that the load picking-up means 5 are free for further loading work of other containers 6. However, the container 6 rests during travel of the stacking crane 1 on the intermediate storage area 15 and is transported into the proximity of its intended location by means of the stacking crane 1, this location having been determined in an optimum manner from an intelligent sequential control of all containers 6. Having arrived at this location, the container 6 can be picked up from the intermediate storage area 15 by the load picking-up means 5 and supplied to the destination adjacent thereto.

The intermediate storage area 15 is formed in such a way that one or two 20 foot containers, one 40 foot container or one 45 foot container can be set-down thereon.

The present invention has been described above in conjunction with an automatically operating, gantry-like stacking crane 1 which can travel on rails 10. The invention can also fundamentally be applied in the case of gantry-like stacking cranes which can travel on rubber tires. A bridge-like design for the stacking cranes with upright rails is also feasible. The intermediate storage area 15 is then suspended on the transverse girder 4. Furthermore, the stacking cranes can also be operated semi-automatically or manually.

### LIST OF REFERENCE NUMERALS

1 stacking crane
2 frame
3 container store
4 transverse girder
5 load picking-up means
6 container
7 supports
8 travel frame
9 running gear unit
10 rails
11 crane trolley
12 raising and lowering direction
13 rotational direction
14 travel direction
15 intermediate storage area
16 mast
17 axis
F crane travel direction

1. A stacking crane for handling containers, said stacking crane having at least one horizontal transverse girder, which can travel in a crane travel direction and along which a crane trolley can travel in and transverse to the crane travel direction, having a load picking-up means for a container, which load picking-up means is suspended on the crane trolley and can be raised and lowered, wherein at least one intermediate storage area for at least one container is disposed on the stacking crane, the intermediate storage area can be reached by the load picking-up means and can travel together with the stacking crane in the crane travel direction, wherein the intermediate storage area is designed in such a way that the intermediate storage area can move between an active position in which a container can be picked up, and a passive position in which no container can be picked up.

2. The stacking crane as claimed in claim 1, wherein the intermediate storage area is able to pivot about a horizontal axis between the active position and the passive position.

3. The stacking crane as claimed in claim 2, wherein the intermediate storage area is disposed below and in the proximity of the transverse girder in such a manner that at least one container can be set down on the intermediate storage area by the load picking-up means.

4. The stacking crane as claimed in claim 3, wherein the intermediate storage area is disposed at the end of the transverse girder.

5. The stacking crane as claimed in claim 4, wherein the stacking crane is formed in a bridge or gantry-like manner.

6. The stacking crane as claimed in claim 5, wherein a plurality of intermediate storage areas are disposed on the stacking crane.

7. The stacking crane as claimed in claim 6, wherein the stacking crane is formed in a gantry construction, the at least one horizontal transverse girder is supported via a plurality of upright supports and the at least one intermediate storage area is disposed on at least one of the supports.

8. The stacking crane as claimed in claim 7, wherein the load picking-up means is guided via a rigid one-piece mast on the crane trolley.

9. A container storage system having a stacking crane as claimed in claim 8, wherein in a container store disposed below the stacking crane, ISO containers are stacked in rows next to and above one another and behind one another in the crane travel direction, the transverse girder straddles the container store and the intermediate storage area is disposed on the stacking crane in a region above a maximum provided container stacking height of the container store.

10. The stacking crane as claimed in claim 4, wherein a plurality of intermediate storage areas are disposed on the stacking crane.

11. The stacking crane as claimed in claim 10, wherein the load picking-up means is guided via a rigid one-piece mast on the crane trolley.

12. The stacking crane as claimed in claim 1, wherein the intermediate storage area is disposed below and in the proximity of the transverse girder in such a manner that at least one container can be set down on the intermediate storage area by the load picking up means.

13. The stacking crane as claimed in claim 12, wherein the intermediate storage area is disposed at the end of the transverse girder.

14. The stacking crane as claimed in claim 1, wherein the stacking crane is formed in a bridge or gantry-like manner.

15. The stacking crane as claimed in claim 1, wherein a plurality of intermediate storage areas are disposed on the stacking crane.

16. The stacking crane as claimed in claim 1, wherein the stacking crane is formed in a gantry construction, the at least one horizontal transverse girder is supported via a plurality of upright supports and the at least one intermediate storage area is disposed on at least one of the supports.

17. The stacking crane as claimed in claim 1, wherein the load picking-up means is guided via a rigid one-piece mast on the crane trolley.

18. The stacking crane as claimed in claim 1, wherein the intermediate storage area is disposed at the end of the transverse girder.

19. The stacking crane as claimed in claim 2, wherein a plurality of intermediate storage areas are disposed on the stacking crane.

20. A container storage system having a stacking crane as claimed in claim 1, wherein in a container store disposed below the stacking crane, ISO containers are stacked in rows next to and above one another and behind one another in the crane travel direction, the transverse girder straddles the container store and the intermediate storage area is disposed on the stacking crane in a region above a maximum provided container stacking height of the container store.
